(19) United States
(12) Patent Application Publication
(10) Pub. No.: US 2011/0047518 A1
(43) Pub. Date: Feb. 24, 2011

(54) PATTERN DETERMINING METHOD

(76) Inventors: Issui Aiba, Mie (JP); Takafumi Taguchi, Kanagawa (JP); Hiromitsu Mashita, Kanagawa (JP); Taiga Uno, Kanagawa (JP); Fumiharu Nakajima, Kanagawa (JP); Toshiya Kotani, Tokyo (JP); Tadahito Fujisawa, Mie (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/860,278

(22) Filed: Aug. 20, 2010

(30) Foreign Application Priority Data
Aug. 21, 2009 (JP) 2009-191855

(51) Int. Cl. G06F 17/50

(52) U.S. Cl. 716/51

(57) ABSTRACT

According to the embodiments, a first representative point is set on outline pattern data on a pattern formed in a process before a processed pattern. Then, a minimum distance from the first representative point to a peripheral pattern is calculated. Then, area of a region with no pattern, which is sandwiched by the first representative point and the peripheral pattern, in a region within a predetermined range from the first representative point is calculated. Then, it is determined whether the first representative point becomes a processing failure by using the minimum distance and the area.

### CROSS-REFERENCE TO RELATED APPLICATIONS

This application is based upon and claims the benefit of priority from the prior Japanese Patent Application No. 2009-191855, filed on Aug. 21, 2009; the entire contents of which are incorporated herein by reference.

### FIELD

Embodiments described herein relate generally to a pattern determining method.

### BACKGROUND

In recent years, with the miniaturization of a device pattern size, it has become difficult to form a pattern having the same shape as a desired design pattern on a substrate. In the lithography field, even if a pattern formation is performed with the minimum resolution, a required device pattern size cannot be formed, so that a device process using a double patterning method is used. As one example of such a double patterning method, there is a side-wall processing process.

The side-wall processing process includes a process of depositing a side-wall film (processing material), and deposit is directly used in a finished circuit pattern formation. In such a process of depositing the side-wall film, the side-wall film is deposited excessively to narrow a pattern interval, which results in a processing failure in some cases. Therefore, it is needed to extract a pattern that is highly likely to be the processing failure as a danger point and correct a mask pattern or the like so that the danger point is eliminated.

However, it is difficult to extract the danger point after processing before depositing the processing material only by determination based on a resist pattern formed in a lithography process or layout data drawn for forming the resist pattern. For example, there is a method of using a processing simulation as a method of extracting the danger point after processing before depositing the processing material. In this method, the danger point needs to be detected by performing the processing simulation on the whole chip, so that there is a problem that a considerably long time is required for the processing simulation.

### BRIEF DESCRIPTION OF THE DRAWINGS

FIG. 1 is a diagram illustrating a configuration of a pattern correcting system according to a first embodiment;

FIG. 2 is a block diagram illustrating a configuration of a pattern determining apparatus according to the first embodiment;

FIG. 3 is a flowchart illustrating a setting process procedure of a risk allowable range;

FIG. 4 is a flowchart illustrating a process procedure of a pattern correcting process;

FIG. 5 is a diagram illustrating a process procedure of a pattern determining process according to the first embodiment;

FIG. 6A and FIG. 6B are diagrams for explaining a representative point and an opening area;

FIG. 7 is a diagram for explaining a detecting process of a dangerous pattern performed in various processes;

FIG. 8 is a diagram for explaining a mask pattern correcting method when the dangerous pattern is detected;

FIG. 9 is a diagram for explaining a pattern determining method according to a second embodiment;

FIG. 10 is a diagram for explaining the pattern determining method according to a third embodiment; and

FIG. 11 is a diagram illustrating a hardware configuration of the pattern determining apparatus.

### DETAILED DESCRIPTION

According to embodiments, a first representative point is set as a position at which a pattern determination is performed on outline pattern data on a pattern formed in a process before a processed pattern to be a target for the pattern determination. Then, a minimum distance from the first representative point to a peripheral pattern arranged around the pattern in which the first representative point is set is calculated. Then, area of a region with no pattern, which is sandwiched by the pattern in which the first representative point is positioned and the peripheral pattern, in a region within a predetermined range from the first representative point is calculated as a first opening area. Then, processing failure information on possibility that the first representative point becomes a processing failure when the first representative point becomes the processed pattern is calculated by using the minimum distance and the first opening area. Then, it is determined whether the first representative point becomes the processing failure by comparing the processing failure information with a predetermined reference range.

Exemplary embodiments of a pattern determining method will be explained below in detail with reference to the accompanying drawings. The present invention is not limited to the following embodiments.

### First Embodiment

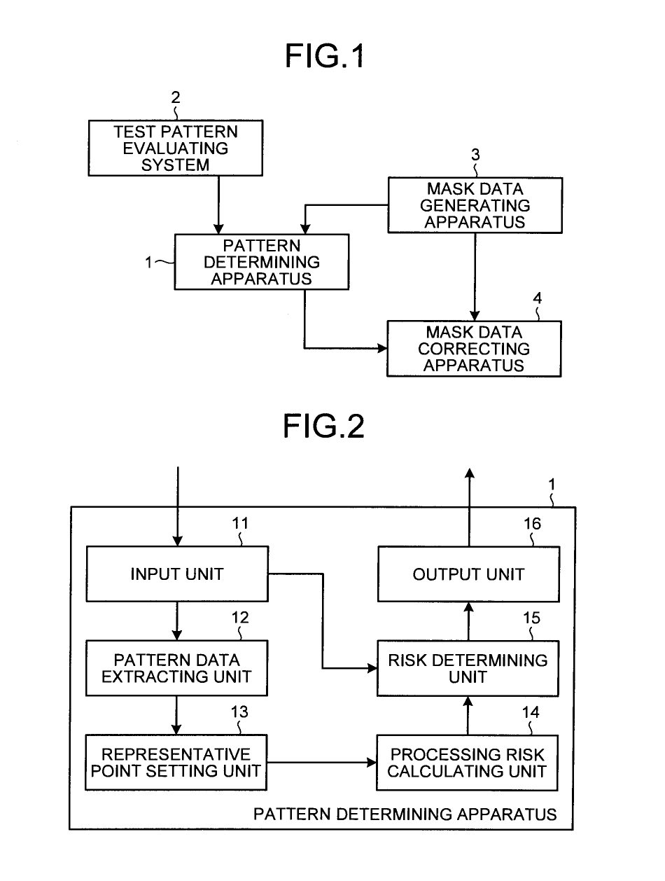

FIG. 1 is a diagram illustrating a configuration of a pattern correcting system according to the first embodiment. The pattern correcting system, for example, is a system that corrects an on-substrate pattern to be formed on a substrate such as a wafer by correcting a mask pattern. The pattern correcting system in the present embodiment extracts a dangerous pattern (danger point) based on area (opening area to be described later) of a portion (portion in which a resist pattern is not arranged) that is open on a region within a predetermined distance from a position (representative point to be described later) to be a target for a pattern determination and a shortest distance (minimum space to be described later) from the representative point to a peripheral resist pattern, and corrects the mask pattern to eliminate the dangerous pattern.

The pattern correcting system is applied to a pattern correction or the like of a semiconductor device in which a semiconductor integrated circuit pattern is formed on a wafer by processing a processing target film at least once or more. In the present embodiment, explanation is given for the case where the pattern correcting system performs the pattern determination (layout verification) on a semiconductor device to be manufactured by using a side-wall processing process.

In a process of depositing a processing material on a pattern formed by a lithography process, such as the side-wall processing process, a deposition amount of deposit is different depending on a layout shape (for example, interval between cores) even if the deposit is deposited for the same amount of time. Therefore, even if there is no problem in the resist pattern in a pattern verification after the lithography, a portion with a narrow pattern interval is generated due to excessive adhesion of a deposited material or a pattern thinning occurs due to insufficient deposition amount of the deposited material in some cases. Therefore, the pattern correcting system in the present embodiment detects a portion to be a pattern failure after depositing the deposit based on a pattern shape of the resist pattern.

The pattern correcting system includes a pattern determining apparatus 1, a test pattern evaluating system 2, a mask data generating apparatus 3, and a mask data correcting apparatus 4. The test pattern evaluating system 2 is a system that sets a determination reference (allowable range of a processing risk) of whether the on-substrate pattern to be formed on the substrate becomes the dangerous pattern (pattern of which possibility to be the pattern failure is higher than a predetermined value). The test pattern evaluating system 2 sets the allowable range of the processing risk (risk allowable range dr1 to be described later) by using a test pattern formed on a test wafer. The test pattern evaluating system 2 sends the set risk allowable range dr1 to the pattern determining apparatus 1.

The mask data generating apparatus 3 generates mask pattern data (product mask pattern data) of a product mask to be an evaluation target by using design layout data. The mask data generating apparatus 3 sends the generated product mask pattern data to the pattern determining apparatus 1 and the mask data correcting apparatus 4.

The pattern determining apparatus 1 is an apparatus, such as a computer, that performs the pattern determination (determination of the risk) of the product mask based on the risk allowable range dr1, a layout of the resist pattern (peripheral resist pattern) arranged around a position (determination target position) at which the pattern determination is performed, the shortest distance from the determination target position to the peripheral resist pattern, and the like. The pattern determining apparatus 1 in the present embodiment, for example, performs the pattern determination of the product mask by performing the pattern determination of the resist pattern formed by using the product mask. The pattern determining apparatus 1 extracts the dangerous pattern from a product mask pattern and sends it to the mask data correcting apparatus 4.

The mask data correcting apparatus 4 is an apparatus that corrects the product mask pattern at a pattern position that is determined by the pattern determining apparatus 1 as the dangerous pattern. The mask data correcting apparatus 4 corrects the product mask pattern by a shape correction of the mask pattern, addition of a dummy pattern, or the like.

FIG. 2 is a block diagram illustrating a configuration of the pattern determining apparatus according to the first embodiment. The pattern determining apparatus 1 includes an input unit 11, a pattern data extracting unit 12, a representative point setting unit 13, a processing risk calculating unit 14, a risk determining unit 15, and an output unit 16.

The input unit 11 inputs the risk allowable range dr1 set in the test pattern evaluating system 2 and the product mask pattern data generated by the mask data generating apparatus 3. The input unit 11 sends the risk allowable range dr1 to the risk determining unit 15 and sends the product mask pattern data to the pattern data extracting unit 12.

The pattern data extracting unit 12 performs a lithography simulation or a graphics operation by using the product mask pattern data input to the input unit 11, and calculates the resist pattern corresponding to the product mask pattern. The resist pattern calculated by the pattern data extracting unit 12 is the resist pattern in the case of performing an exposure process on a wafer by using the product mask. The pattern data extracting unit 12 extracts outline data from the calculated resist pattern and converts the extracted outline data into image data (outline image data). The pattern data extracting unit 12 sends the outline image data to the representative point setting unit 13.

The representative point setting unit 13 divides (edge division) an edge line of the resist pattern into a plurality of edge lines by using the outline image data. The representative point setting unit 13, for example, divides the edge line of the resist pattern into equal intervals. The representative point setting unit 13 sets the representative point on each edge line after the division. The representative point setting unit 13 sends information on the positions of the representative points set on the resist pattern to the processing risk calculating unit 14.

The processing risk calculating unit 14 sets the representative point as the determination target position and calculates a processed shape determination value at the representative point based on the layout of the peripheral resist pattern arranged around the representative point and the shortest distance from the representative point to the peripheral resist pattern. Specifically, the processing risk calculating unit 14 calculates area of a portion (portion in which the resist pattern is not arranged) that is open on a region within a predetermined distance from the representative point as an opening area. The opening area is area of a region (region with no pattern) sandwiched by a pattern in which the representative point is positioned and the peripheral resist pattern in a region (circular region) within the predetermined distance from the representative point. Moreover, the processing risk calculating unit 14 calculates the shortest distance from the representative point to the peripheral resist pattern as the minimum space. The processing risk calculating unit 14 calculates a processed shape determination value D by D=(opening area)/(minimum space). The processing risk calculating unit 14 sends the calculated processed shape determination value D to the risk determining unit 15.

The risk determining unit 15 determines whether the representative point is the danger point by comparing the processed shape determination value D with the risk allowable range dr1. The risk determining unit 15 sends the position of the representative point determined as the danger point to the output unit 16. The output unit 16 outputs the position of the representative point determined as the danger point by the risk determining unit 15.

Next, a process procedure of a pattern correcting process performed by the pattern correcting system is explained. First, a setting process of the risk allowable range dr1 is explained, and thereafter the pattern correcting process and a pattern determining process are explained.

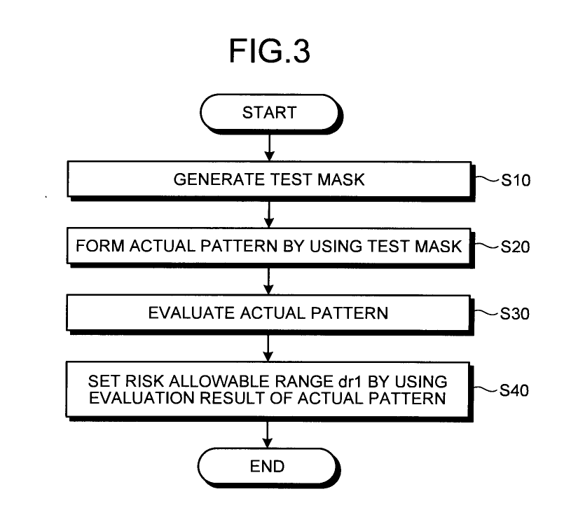

FIG. 3 is a flowchart illustrating the setting process procedure of the risk allowable range. In the test pattern evaluating system 2, a test mask for setting the risk allowable range dr1 beforehand is generated in advance (Step S10). In this test mask, patterns having various shapes, such as a line & space pattern and a crank pattern, are formed with various dimensions.

Thereafter, in the test pattern evaluating system 2, an actual pattern is formed on a wafer by using the test mask (Step S20). Specifically, the wafer on which a resist is applied is exposed by using the test mask, and thereafter the wafer is developed to form the resist pattern. Then, the resist pattern or a film pattern formed by transferring the resist pattern onto a base is subjected to slimming and a side-wall film is deposited with the slimmed pattern as a core. Moreover, after removing the core, a lower layer side of the side-wall film is etched with the side-wall film as a mask. Whereby, the actual pattern corresponding to the side-wall film is formed on the wafer.

After the actual pattern is formed, this actual pattern is evaluated (Step S30). Specifically, a portion that is highly likely to be a processing failure is extracted as the dangerous pattern from the actual pattern. Then, the pattern determining apparatus 1 calculates the processed shape determination value D at the position extracted as the dangerous pattern. When the value of the processed shape determination value D is large, the possibility (processing risk) that the side-wall film becomes small to cause a pattern collapse becomes high. On the other hand, when the value of the processed shape determination value D is small, the possibility that the side-wall film collides with the adjacent side-wall film to cause short circuit becomes high.

After the dangerous pattern is extracted, a correlation between the processed shape determination value D and the possibility to be the processing failure is calculated, and the risk allowable range dr1 is set based on this correlation. In other words, the risk allowable range dr1 is set by using an evaluation result of the actual pattern (Step S40). The size of the risk allowable range dr1 is adjusted arbitrary by a user of the pattern correcting system. For example, in the case where even a small processing risk is set to be a target for the pattern correction, the risk allowable range dr1 is set to a narrow range, and in the case where only a large processing risk is set to be a target for the pattern correction, the risk allowable range dr1 is set to a wide range. The risk allowable range dr1 set in the test pattern evaluating system 2 is input to the pattern determining apparatus 1.

In FIG. 3, explanation is given for the case of setting the risk allowable range dr1 by using the evaluation result of the actual pattern; however, the risk allowable range dr1 can be set by using a processing simulation or the like on mask data on the test mask. Moreover, instead of or in addition to the range of the risk allowable range dr1, it is applicable to adjust the size of the range of the circular region that is set such that the distance from the representative point when calculating the processed shape determination value D is variable.

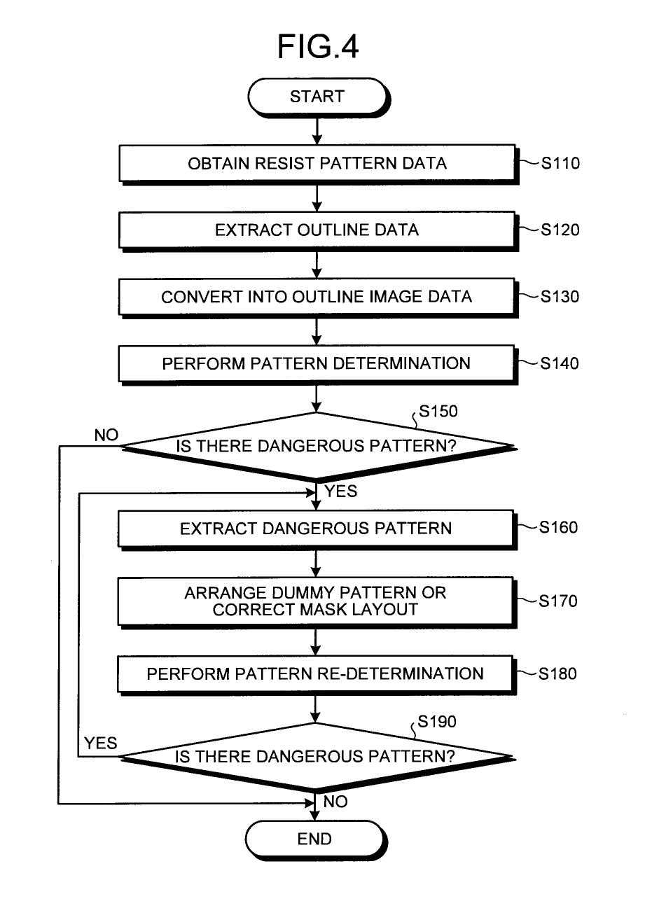

Next, the pattern correcting process performed by the pattern correcting system is explained. FIG. 4 is a flowchart illustrating a process procedure of the pattern correcting process. The risk allowable range dr1 set in the test pattern evaluating system 2 and the product mask pattern data generated by the mask data generating apparatus 3 are input to the input unit 11 of the pattern determining apparatus 1. The input unit 11 sends the risk allowable range dr1 to the risk determining unit 15 and the product mask pattern data to the pattern data extracting unit 12.

The pattern data extracting unit 12 performs the lithography simulation by using the product mask pattern data and calculates the resist pattern corresponding to the product mask pattern. Whereby, the pattern data extracting unit 12 obtains the resist pattern data on the resist pattern (Step S110).

The pattern data extracting unit 12 extracts the outline data from the calculated resist pattern and converts the extracted outline data into the outline image data (Steps S120 and S130). The pattern data extracting unit 12 sends the outline image data to the representative point setting unit 13.

The representative point setting unit 13 sets the position (representative point) to be the determination target on the edge line of the resist pattern by using the outline image data. The processing risk calculating unit 14 calculates the processed shape determination value D at the representative point, and the risk determining unit 15 compares the processed shape determination value D with the risk allowable range dr1, to perform the pattern determination at the representative point (Step S140). When the representative point is the danger point, the risk determining unit 15 determines that this representative point is the dangerous pattern.

When there is no dangerous pattern in the resist pattern (No at Step S150), the pattern correcting process ends. On the other hand, when there is the dangerous pattern in the resist pattern (Yes at Step S150), the dangerous pattern is extracted (Step S160). Then, a dummy pattern is arranged near the dangerous pattern or the mask layout near the dangerous pattern is corrected to correct the mask pattern (Step S170).

Thereafter, a pattern re-determination of the resist pattern is performed by using the mask pattern data after correcting the mask pattern (Step S180). At this time, the pattern re-determination of the resist pattern is performed by the process similar to the process of Steps S110 to 5140.

When there is the dangerous pattern in the resist pattern (Yes at Step S190), the process of Steps S160 to S190 is repeated. When there is no dangerous pattern in the resist pattern (No at Step S190), the pattern correcting process ends.

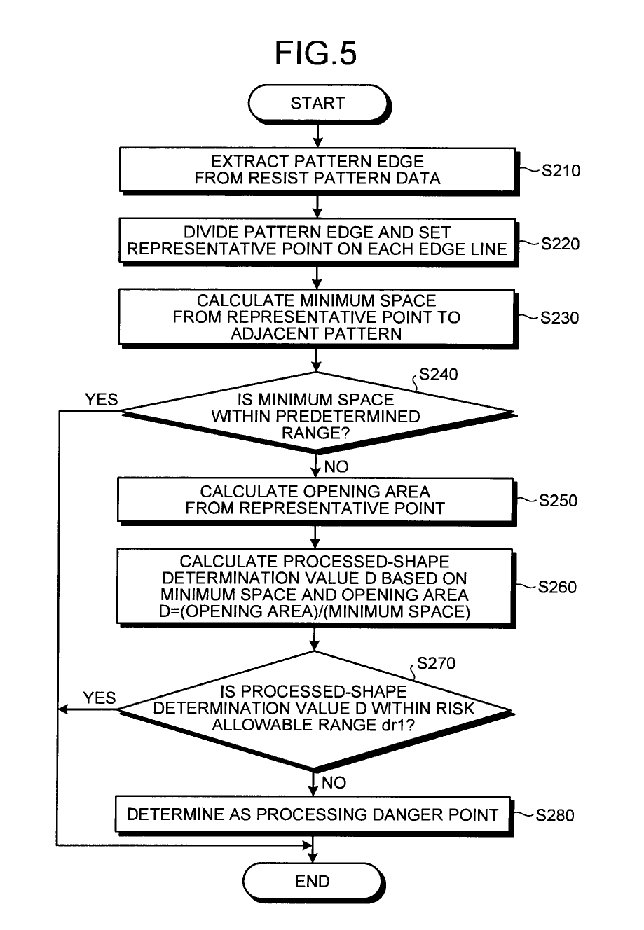

Next, the pattern determining process is explained, which is one of the main characteristics of the present embodiment. FIG. 5 is a diagram illustrating a process procedure of the pattern determining process according to the first embodiment. The danger point after the lithography is extracted in advance, for example, by the lithography simulation. Then, while ensuring a predetermined exposure margin, an exposure condition in the lithography process is set in advance so that the danger point is not generated after the lithography. Whereby, the pattern determining process by the pattern determining apparatus 1 is started in a state where there is no danger point after the lithography.

The risk allowable range dr1 set in the test pattern evaluating system 2 and the product mask pattern data generated by the mask data generating apparatus 3 are input to the input unit 11 of the pattern determining apparatus 1. The input unit 11 sends the risk allowable range dr1 to the risk determining unit 15 and sends the product mask pattern data to the pattern data extracting unit 12.

The pattern data extracting unit 12 performs the lithography simulation by performing Boolean operation or the like on the product mask pattern data, and calculates the resist pattern corresponding to the product mask pattern. Moreover, the pattern data extracting unit 12 extracts the outline data from the calculated resist pattern and converts the extracted outline data into the outline image data. Then, the pattern data extracting unit 12 sends the outline image data to the representative point setting unit 13.

The representative point setting unit 13 extracts the edge line of the resist pattern from the outline image data (Step S210). Then, the representative point setting unit 13 divides the edge line into a plurality of edge lines and sets the representative point on each edge line after the division (Step S220). The representative point setting unit 13 sends information on the position of each representative point set on the resist pattern to the processing risk calculating unit 14.

The processing risk calculating unit 14 calculates the minimum space from each representative point to the peripheral resist pattern (Step S230). Then, the processing risk calculating unit 14 determines whether the value of the minimum space is within a predetermined range (Step S240). When the value of the minimum space is the predetermined value (determination reference value) or more (Yes at Step S240), the possibility that the representative point becomes the dangerous pattern is low, so that this representative point is excluded from the target for the pattern determination. Whereby, the processing risk calculating unit 14 extracts only the representative point whose value of the minimum space is less than the predetermined value. The determination reference value of the minimum space in this example is a value set by using a test pattern or the like formed with various minimum spaces in advance. The determination reference value of the minimum space is set based on a verification of whether a pattern after processing becomes the dangerous pattern when a lower layer of the side-wall film is processed.

When the value of the minimum space is less than the predetermined value (No at Step S240), the processing risk calculating unit 14 calculates area of a portion that is open on a region within a predetermined distance from the representative point as the opening area (Step S250).

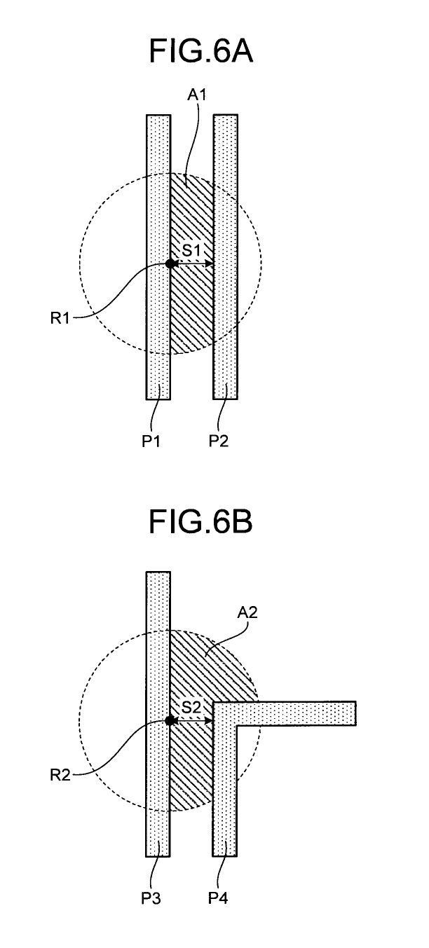

FIG. 6A and FIG. 6B are diagrams for explaining the representative point and the opening area. FIGS. 6A and 6B illustrate top views of the resist pattern to be the determination target and the peripheral resist pattern. Moreover, FIG. 6A illustrates the case where the peripheral resist pattern is a line pattern, and FIG. 6B illustrates the case where the peripheral resist pattern is a crank pattern.

In the case of FIG. 6A, in the circular region within a predetermined distance from a representative point R1, area of a region sandwiched by the edge line on a resist pattern P1 in which the representative point R1 is positioned and the edge line of a resist pattern P2 to be the peripheral resist pattern on the side of the representative point R1 is the opening area (A1). FIG. 6A illustrates the case where the minimum space from the representative point R1 to the resist pattern P2 is S1.

Moreover, in the case of FIG. 6B, in the circular region within a predetermined distance from a representative point R2, area of a region sandwiched by the edge line on a resist pattern P3 in which the representative point R2 is positioned and the edge line of a crank pattern P4 to be the peripheral resist pattern on the side of the representative point R2 is the opening area (A2). FIG. 6B illustrates the case where the minimum space from the representative point R2 to the crank pattern P4 is S2. In the followings, the representative point such as the representative points R1 and R2 is explained as a representative point Rx in some cases.

The processing risk calculating unit 14 calculates the processed shape determination value D by D=(opening area)/(minimum space) (Step S260). In the case of FIG. 6A, the processed shape determination value D becomes D=A1/S1, and in the case of FIG. 6B, the processed shape determination value D becomes D=A2/S2. The processing risk calculating unit 14 sends each calculated processed shape determination value D to the risk determining unit 15.

The risk determining unit 15 compares each processed shape determination value D with the risk allowable range dr1 and determines whether the processed shape determination value D at the representative point Rx is within the risk allowable range dr1. When the processed shape determination value D at the representative point Rx is within the range of the risk allowable range dr1 (Yes at Step S270), the risk determining unit 15 determines that the representative point Rx is not the dangerous pattern. On the other hand, when the processed shape determination value D at the representative point Rx is not within the range of the risk allowable range dr1 (No at Step S270), the risk determining unit 15 determines that the representative point Rx is the dangerous pattern (Step S280).

In this manner, the present embodiment focuses on the fact that the deposition amount of the side-wall film is different depending on the space or the opening area from the resist pattern and detects the dangerous pattern from the representative points after processing based on the opening area.

In the present embodiment, explanation is given for the case of detecting the dangerous pattern on the data on the resist pattern; however, the dangerous pattern can be detected on the design layout data. For example, the danger point can be detected on the design layout data by using a tool such as DRC (design rule check).

Moreover, the dangerous pattern can be detected based on a pattern shape in various processes formed after slimming the pattern. For example, the process of detecting the dangerous pattern is performed after slimming a pattern, after depositing the side-wall film, after removing the core, and the like in addition to after forming the resist pattern.

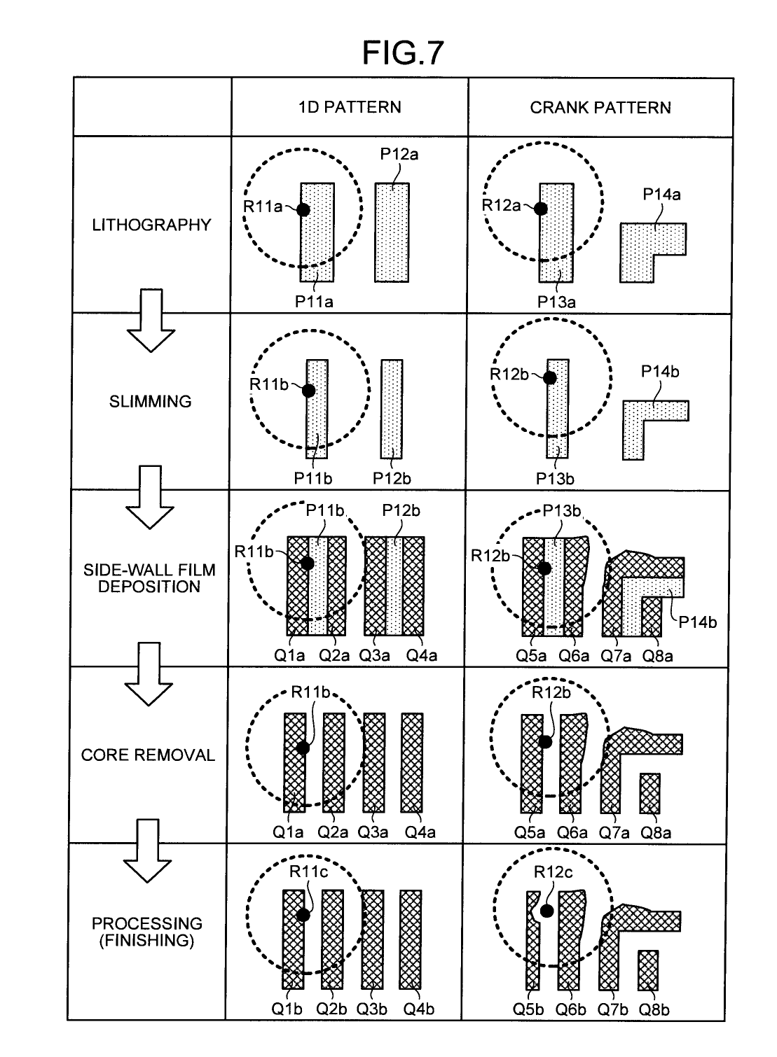

FIG. 7 is a diagram for explaining a detecting process of the dangerous pattern performed in various processes. FIG. 7 illustrates top views of a pattern to be the determination target, the peripheral pattern, and the like. FIG. 7 illustrates the detecting process of the dangerous pattern performed after the lithography process (at the time of forming the resist pattern), after the slimming process, after the side-wall film deposition, and after the core removal, and a pattern shape (detection result of the dangerous pattern) after processing the lower layer film. FIG. 7 illustrates the case where the peripheral pattern is the line pattern (1D pattern) and the case where the peripheral pattern is the crank pattern.

First, the case where the peripheral pattern is the 1D pattern is explained. When the peripheral pattern is the 1D pattern, in the case after the lithography process, it is determined whether a representative point R11a is the dangerous pattern based on the position of a representative point R11a set on a resist pattern P11a, the opening area on a region within a predetermined distance from the representative point R11a, and the minimum space from the representative point R11a to a resist pattern P12a to be the peripheral pattern.

When the resist patterns P11a and P12a are slimmed, they become slimming patterns P11b and P12b, respectively. The position of a representative point R11b set on the slimming pattern P11b corresponds to the position of the representative point R11a set on the slimming pattern P11a, and is displaced from the position of the representative point R11a by the slimmed amount of the resist pattern P11a.

In the case of detecting the dangerous pattern after the slimming process, it is determined whether the representative point R11b is the dangerous pattern based on the position of the representative point R11b set on the slimming pattern P11b, the opening area on a region within a predetermined distance from the representative point R11b, and the minimum space from the representative point R11b to the slimming pattern P12b to be the peripheral pattern.

When the side-wall film is deposited on the slimming patterns P11b and P12b, side-wall patterns Q1a and Q2a are formed on a side-wall portion of the slimming pattern P11b, and side-wall patterns Q3a and Q4a are formed on a side-wall portion of the slimming pattern P12b. The side-wall patterns Q1a to Q4a are formed into shapes affected by the shapes of the slimming patterns P11b and P12b, the minimum space from the peripheral pattern, the opening area, and the like.

In the case of detecting the dangerous pattern after the side-wall film deposition, it is determined whether the representative point R11b is the dangerous pattern based on the position of the representative point R11b set on the slimming pattern P11b (side-wall pattern Q1a), the opening area (area of a region excluding the slimming patterns P11b and P12b and the side-wall patterns Q1a to Q4a) on a region within a predetermined distance from the representative point R11b, and the minimum space from the representative point R11b to the slimming pattern P12b to be the peripheral pattern.

After the side-wall patterns Q1a to Q4a are deposited, when the slimming patterns P11b and P12b that were the cores are removed, the side-wall patterns Q1a to Q4a are left. In the case of detecting the dangerous pattern after the core removal, it is determined whether the representative point R11b is the dangerous pattern based on the position of the representative point R11b set on the side-wall pattern Q1a, the opening area (area of a region excluding the side-wall patterns Q1a to Q4a) on a region within a predetermined distance from the representative point R11b, and the minimum space from the representative point R11b to the side-wall patterns Q2a to Q4a to be the peripheral patterns. At this time, the processing risk calculating unit 14 calculates the processed shape determination value D with respect to the side-wall patterns Q2a to Q4a from the representative point R11b for each of the side-wall patterns Q2a to Q4a. Then, the risk determining unit 15 determines whether the representative point R11b is the dangerous pattern for each of the side-wall patterns Q2a to Q4a. The risk determining unit 15 determines that the representative point R11b is the dangerous pattern if at least one of the processed shape determination values D calculated based on the side-wall patterns Q2a to Q4a is out of the range of the risk allowable range dr1.

In this manner, the process of detecting the dangerous pattern can be any of the processes after forming the resist pattern, after slimming a pattern, after depositing the side-wall film, after removing the core, and the like so long as it is before processing the lower layer film.

After removing the cores, when the lower layer film is actually subjected to etching processing with the side-wall patterns Q1a to Q4a as a mask, processed patterns Q1b to Q4b are formed. The processed patterns Q1b to Q4b are formed into shapes affected by the pattern shapes of the side-wall patterns Q1a to Q4a, the minimum space from the peripheral pattern, the opening area, and the like. The position of the representative point R11c after processing shown in FIG. 7 corresponds to the positions of the representative points R11a and R11b set before the core removal. When the lower layer film is actually processed, the representative point R11c becomes the processing failure pattern in some cases; however, in the 1D pattern shown in FIG. 7, the case is illustrated in which failure does not occur at the representative point R11c even after processing of the lower layer film (finished shape).

Moreover, in the case where the peripheral pattern is the crank pattern again, the dangerous pattern is extracted by the process similar to the case where the peripheral pattern is the 1D pattern. Specifically, in the case after the lithography process, it is determined whether a representative point R12a is the dangerous pattern based on the position of the representative point R12a set on a resist pattern P13a, the opening area on a region within a predetermined distance from the representative point R12a, and the minimum space from the representative point R12a to a resist pattern P14a to be the peripheral pattern.

When the resist patterns P13a and P14a are slimmed, they become slimming patterns P13b and P14b, respectively. The position of the representative point R12b set on the slimming pattern P13b corresponds to the position of the representative point R12a set on the slimming pattern P13a, and is displaced from the position of the representative point R12a by the slimmed amount of the resist pattern P13a.

In the case of detecting the dangerous pattern after the slimming process, it is determined whether the representative point R12b is the dangerous pattern based on the position of the representative point R12b set on the slimming pattern P13b, the opening area on a region within a predetermined distance from the representative point R12b, and the minimum space from the representative point R12b to the slimming pattern P14b to be the peripheral pattern.

When the side-wall film is deposited on the slimming patterns P13b and P14b, side-wall patterns Q5a and Q6a are formed on a side-wall portion of the slimming pattern P13b, and side-wall patterns Q7a and Q8a are formed on a side-wall portion of the slimming pattern P14b. The side-wall patterns Q5a to Q8a are formed into shapes affected by the shapes of the slimming patterns P13b and P14b, the minimum space from the peripheral pattern, the opening area, and the like.

In the case of detecting the dangerous pattern after the side-wall film deposition, it is determined whether the representative point R12b is the dangerous pattern based on the position of the representative point R12b set on the slimming pattern P13b (side-wall pattern Q5a), the opening area (area of a region excluding the slimming patterns P13b and P14b and the side-wall patterns Q5a to Q8a) on a region within a predetermined distance from the representative point R12b, and the minimum space from the representative point R12b to the slimming pattern P14b to be the peripheral pattern.

After the side-wall patterns Q5a to Q8a are deposited, when the slimming patterns P13b and P14b that were the cores are removed, the side-wall patterns Q5a to Q8a are left. In the case of detecting the dangerous pattern after the core removal, it is determined whether the representative point R12b is the dangerous pattern based on the position of the representative point R12b set on the side-wall pattern Q5a, the opening area (area of a region excluding the side-wall patterns Q5a to Q8a) on a region within a predetermined distance from the representative point R12b, and the minimum space from the representative point R12b to the side-wall patterns Q6a to Q8a. At this time, the processing risk calculating unit 14 calculates the processed shape determination value D with respect to the side-wall patterns Q6a to Q8a from the representative point R12b for each of the side-wall patterns Q6a to Q8a. Then, the risk determining unit 15 determines whether the representative point R12b is the dangerous pattern for each of the side-wall patterns Q6a to Q8a. The risk determining unit 15 determines that the representative point R12b is the danger point if at least one of the processed shape determination values D calculated based on the side-wall patterns Q6a to Q8a is out of the range of the risk allowable range dr1.

After removing the cores, when the lower layer film is actually subjected to the etching processing with the side-wall patterns Q5a to Q8a as a mask, processed patterns Q5b to Q8b are formed. The processed patterns Q5b to Q8b are formed into shapes affected by the pattern shapes of the side-wall patterns Q5a to Q8a, the minimum space from the peripheral pattern, the opening area, and the like. The position of a representative point R12c after processing shown in FIG. 7 corresponds to the positions of the representative points R12a and R12b set before the core removal. In the crank pattern shown in FIG. 7, the case is illustrated in which the representative point R12c after processing of the lower layer film becomes failure.

In the case of detecting the dangerous pattern in the above each process, the pattern determining apparatus 1 calculates the pattern shape in each process by the processing simulation or the like and detects the dangerous pattern by using the calculated pattern shape. At this time, the pattern shape in each process is calculated by the pattern data extracting unit 12 performing the processing simulation or the like. Alternatively, the pattern shape can be calculated by tracing a processing surface by using SEM or the like after actually processing a test wafer in each process, and extracting a pattern outline from an obtained image and converting it into image data by the pattern determining apparatus 1. Moreover, the risk allowable range dr1 can be set for each process of detecting the dangerous pattern.

Furthermore, in FIG. 7, explanation is given for the case of determining whether the processed patterns Q1b to Q4b and Q5b to Q8b after processing the lower layer film become the processing dangerous pattern; however, it is applicable to determine whether the side-wall pattern after processing the lower layer film becomes the processing dangerous pattern.

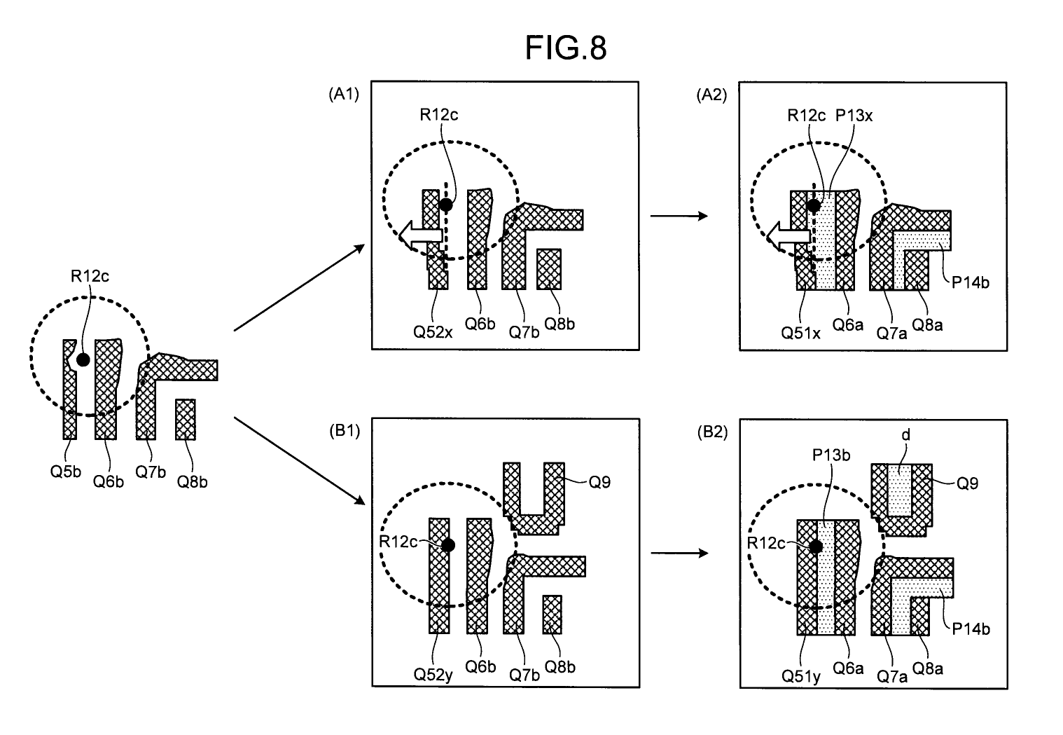

Next, explanation is given for a mask pattern correcting method when the dangerous pattern is detected. FIG. 8 is a diagram for explaining the mask pattern correcting method when the dangerous pattern is detected. In this example, the case is explained in which the peripheral pattern is the crank pattern.

A portion at which periodicity of the line & space is low, such as the representative point R12c, is affected by the side-wall patterns Q6a to Q8a to be the peripheral patterns after processing the lower layer film with the above side-wall patterns Q5a to Q8a as a mask, and thus a proximity (processed pattern Q5b) of the representative point R12c becomes failure in some cases.

For example, as a result of detecting presence or absence of the dangerous pattern in any of the processes after forming the resist pattern, after slimming a pattern, after depositing the side-wall film, after removing the core, and the like, the width of the processed pattern Q5b becomes thin and the possibility of collapse of the processed pattern Q5b is detected in some cases. In this case, in the present embodiment, a layout correction, in which, for example, a processing variation when processing the lower layer film is taken into account, is performed. At this time, the layout correction is performed so that the representative point that becomes the dangerous pattern does not become the dangerous pattern (i.e., for making the processed shape determination value D fall within the risk allowable range dr1).

Specifically, for thickening the width of the processed pattern Q5b like a processed pattern Q52x (A1), the side-wall pattern Q5a is thickened like a side-wall pattern Q51x (A2). For this purpose, the slimming pattern P13b used for forming the processed pattern Q5b is changed in advance to a slimming pattern P13x that is thickened in a direction of the processed pattern Q5b whose pattern width becomes thin. Then, for forming the slimming pattern P13x, the resist pattern P13a corresponding to the slimming pattern P13b is changed to have a thickness corresponding to the slimming pattern P13x in advance to become the slimming pattern P13x after the slimming. Then, for changing the resist pattern P13a to have a thickness corresponding to the slimming pattern P13x, the mask pattern corresponding to the resist pattern P13a is changed to have a thickness corresponding to the slimming pattern P13x in advance.

Whereby, when a pattern is formed on a wafer by using the mask pattern on which the layout correction is performed, the pattern after processing the lower layer film becomes the processed pattern Q52x with no crack different from the processed pattern Q5b. The position of the representative point R12c (representative points R12a and R12b) moves away from the peripheral patterns (side-wall patterns Q6a to Q8a), so that the representative point R12c is not easily affected by the peripheral patterns. Consequently, “A” in the processed shape determination value D=A/S changes, so that the representative point R12c does not become a failure pattern.

Moreover, when there is the possibility that the width of the processed pattern Q5b becomes thin and the processed pattern Q5b collapses, a dummy pattern can be arranged around the representative points R12a and R12b. Specifically, for thickening the width of the processed pattern Q5b like a processed pattern Q52y (B1), the side-wall pattern Q5a is thickened like a side-wall pattern Q51y (B2). For this purpose, a slimming pattern d is formed around the slimming pattern P13d and a side-wall pattern Q9 is formed on the side wall of the slimming pattern d in advance. Then, for forming the side-wall pattern Q9, the resist pattern is changed in advance so that the peripheral resist pattern corresponding to the slimming pattern d is formed around the resist pattern P13a. Then, for changing the resist pattern, the mask pattern corresponding to the slimming pattern d is arranged around the mask pattern corresponding to the resist pattern P13a in advance.

Whereby, when a pattern is formed on a wafer by using the mask pattern on which the layout correction is performed, the pattern after processing the lower layer film becomes the processed pattern Q52y with no crack different from the processed pattern Q5b. Therefore, it is prevented that the representative point R12c is affected by the side-wall patterns Q6a to Q8a and the side-wall pattern Q9, and consequently the representative point R12c becomes a failure pattern. In other words, “S” in the processed shape determination value D=A/S is changed, so that the dangerous pattern is prevented from being generated. In this manner, because the dangerous pattern is extracted in a design layout stage, the processing failure can be reduced, and consequently a developing TAT of the product mask can be reduced.

Correction of the mask pattern by the pattern correcting system is performed, for example, for each layer of a wafer process. Then, a semiconductor device (semiconductor integrated circuit) is manufactured by using the product mask in which the mask pattern is corrected as needed or the product mask that is determined to pass. Specifically, the product mask is generated by using the mask pattern after correction or the mask pattern that is determined to pass, and exposure is performed on a wafer on which resist is applied by using the product mask, and thereafter the wafer is developed to form the resist pattern on the wafer. Then, for example, the side-wall film is deposited with the resist pattern as the core and the resist pattern is removed, and then the lower layer side of the side-wall film is etched with the side-wall film as a mask. Whereby, an actual pattern corresponding to the side-wall film is formed on the wafer. When manufacturing a semiconductor device, the above described pattern determination, pattern correction, exposure process, development process, deposition process of the side-wall film, etching process, and the like are repeated for each layer.

In the present embodiment, the configuration is such that the mask data generating apparatus 3 and the mask data correcting apparatus 4 are provided separately; however, the mask data generating apparatus 3 and the mask data correcting apparatus 4 can be integrated into one apparatus. Moreover, the configuration is such that the pattern determining apparatus 1 and the mask data generating apparatus 3 are provided separately; however, the pattern determining apparatus 1 and the mask data generating apparatus 3 can be integrated into one apparatus.

Moreover, in the present embodiment, explanation is given for the pattern determination in the case of performing the pattern formation on a wafer by using the side-wall processing process; however, the pattern correcting system can perform the pattern determination in the case of performing the pattern formation on a wafer by a process other than the side-wall processing process.

Furthermore, in the present embodiment, the case is explained in which the processed shape determination value D is calculated by D=(opening area)/(minimum space); however, the processed shape determination value D can be calculated by using any equation so long as the equation uses the opening area and the minimum space.

In the present embodiment, it is determined whether the representative point is the dangerous pattern for the representative point whose minimum space is smaller than a predetermined value among the representative points; however, it is applicable to determine whether the representative point is the dangerous pattern for all of the representative points. Moreover, after determining whether the representative point is the dangerous pattern for all of the representative points, the representative point whose minimum space is the predetermined value or more can be excluded from the dangerous pattern.

Furthermore, as a countermeasure when the dangerous pattern is detected, it is applicable to change the pattern size after the lithography by changing process conditions (such as dose in an exposure condition, and σ and an aberration condition of an exposure apparatus) other than the layout change. Moreover, it is also applicable to prevent the dangerous pattern from being generated by changing the processed shape determination value D by combining the process conditions such as the dose, σ, and the aberration condition.

In this manner, according to the first embodiment, the processed shape determination value D is calculated by using the opening area and the minimum space, and it is determined whether to be the processing failure after processing based on the calculated processed shape determination value D, so that it is possible to easily and promptly determine whether to be the processing failure before the pattern formation.

Moreover, because the mask pattern is corrected so that the processed shape determination value D at the representative point falls within the risk allowable range dr1, the processing failure of a pattern formed on a wafer can be reduced.

Consequently, the dangerous pattern in the processing process, which is generated when manufacturing a semiconductor device, can be detected by using the outline image data on the resist pattern without performing the processing simulation. Thus, the dangerous pattern can be detected in a design stage of the mask pattern, so that the development TAT of a product can be shortened.

### Second Embodiment

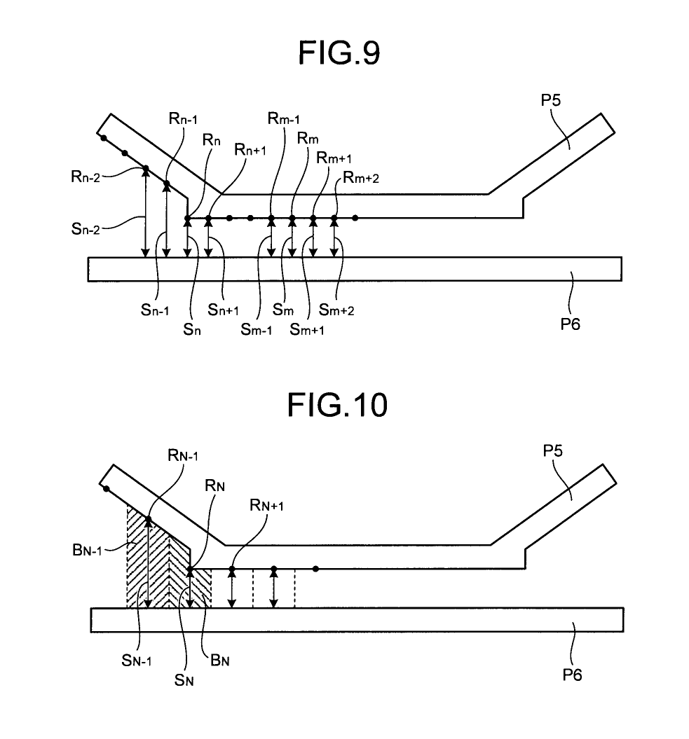

Next, the second embodiment of this invention is explained with reference to FIG. 9. In the second embodiment, the processed shape determination value is calculated by using a change rate of the minimum space between adjacent representative points.

FIG. 9 is a diagram for explaining the pattern determining method according to the second embodiment. FIG. 9 illustrates a top view of the resist pattern to be the determination target and the peripheral resist pattern. First, in the similar manner to the pattern determination in the first embodiment, the pattern data extracting unit 12 extracts the outline data on the resist pattern as a pre-processed pattern of a processing target film and converts the extracted outline data into the outline image data. Then, the representative point setting unit 13 divides the edge line of the resist pattern into a plurality of edge lines by using the outline image data, and sets the representative point on each edge line.

Specifically, the representative point setting unit 13 in the present embodiment sets a plurality of representative points Rn−2, Rn−1, Rn, and Rn+1 on the edge lines of a resist pattern P5 to be the determination target. In this example, the representative point Rn−2 is adjacent to the representative point Rn−1, the representative point Rn−1 is adjacent to the representative point Rn, and the representative point Rn is adjacent to the representative point Rn+1.

Then, the processing risk calculating unit 14 calculates Sn−2, Sn−1, Sn, and Sn+1 as the minimum spaces at the representative points Rn−2, Rn−1, Rn, and Rn+1, respectively. Moreover, the processing risk calculating unit 14 in the present embodiment calculates a ratio (absolute value of change rate) of the minimum space between the adjacent representative points as the processed shape determination value.

Specifically, the processing risk calculating unit 14 calculates a processed shape determination value Dn−1 at the representative point Rn−1 by Dn−1=(Sn−1)/(Sn−2). The processing risk calculating unit 14 calculates a processed shape determination value Dn at the representative point Rn by Dn=(Sn)/(Sn−1). The processing risk calculating unit 14 calculates a processed shape determination value Dn+1 at the representative point Rn+1 by Dn+1=(Sn+1)/(Sn).

The risk determining unit 15 determines whether the representative points are the danger point by comparing the calculated processed shape determination values Dn−1, Dn, and Dn+1 with a risk allowable range dr2. In the present embodiment, in the similar manner to the risk allowable range dr1 explained in the first embodiment, a test mask for setting the risk allowable range dr2 is generated in advance. Then, an actual pattern is formed on a wafer by using the test mask and this actual pattern is evaluated to set the risk allowable range dr2 in advance.

The representative point at which the processed shape determination value takes a large value is a point at which the minimum space changes rapidly compared with the minimum space at the adjacent representative point. The representative point that corresponds to the processed shape determination value indicating a value smaller than the risk allowable range dr2 among the processed shape determination values Dn−1, Dn, and Dn+1 is a position that is highly likely to be the processing failure. The risk determining unit 15 extracts the representative point corresponding to the processed shape determination value indicating a value smaller than the risk allowable range dr2 as the dangerous pattern. For example, in the case of the example shown in FIG. 9, the processed shape determination value Dn at the representative point Rn becomes a small value, and if this processed shape determination value Dn is smaller than the risk allowable range dr2, the representative point Rn is extracted as the dangerous pattern. Then, after the dangerous pattern is extracted, the mask pattern is corrected so that the processed shape determination value at the representative point that becomes the dangerous pattern falls within the risk allowable range dr2. For example, the mask pattern is corrected to change Sn or Sn−1.

On the other hand, the minimum spaces at representative points Rm−1, Rm, Rm+1, and Rm+2 are Sm−1, Sm, Sm+1, and Sm+2, respectively, which are all the same value. The processed shape determination value Dm at the representative point Rm is Dm=(Sm)/(Sm−1)=1. The processed shape determination value Dm+1 at the representative point Rm+1 is Dm+1=(Sm+1)/(Sm+2)=1. In this manner, in a portion in which a pattern as the determination target and the peripheral pattern are arranged in parallel, the minimum space at each representative point is constant, so that the value of the processed shape determination value also becomes constant. Therefore, if a certain representative point is not the dangerous pattern, the representative points adjacent to this representative point do not become the dangerous pattern.

In the present embodiment, explanation is given for the case where the processed shape determination value is calculated by the processed shape determination value=(minimum space at representative point to be determination target)/(minimum space at adjacent representative point); however, the processed shape determination value can be calculated by using any equation so long as the equation uses the minimum space at the representative point to be the determination target and the minimum space at the adjacent representative point.

In this manner, according to the second embodiment, the processed shape determination value is calculated by using a ratio between the minimum space at the representative point to be the determination target and the minimum space at the adjacent representative point, and it is determined whether to be the processing failure after processing based on the calculated processed shape determination value, so that it is possible to easily and promptly determine whether to be the processing failure before the pattern formation.

### Third Embodiment

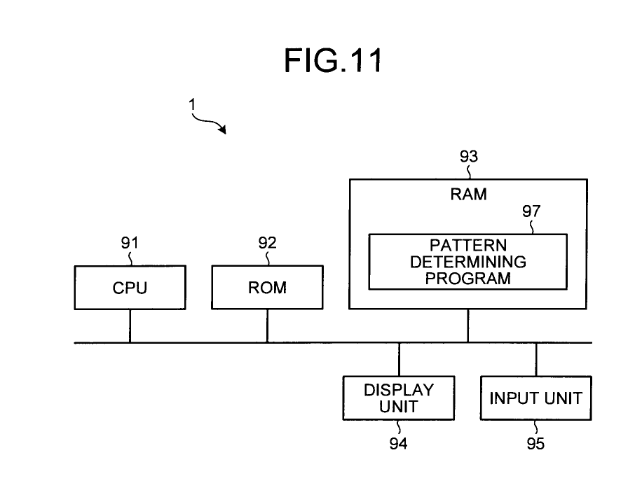

Next, the third embodiment of this invention is explained with reference to FIG. 10 and FIG. 11. In the third embodiment, the processed shape determination value is calculated by using a difference of the opening area between adjacent representative points.

FIG. 10 is a diagram for explaining the pattern determining method according to the third embodiment. FIG. 10 illustrates a top view of the resist pattern to be the determination target and the peripheral resist pattern. Explanation of the process similar to the pattern determining method in the first embodiment or the second embodiment is omitted.

The representative point setting unit 13 in the present embodiment sets a plurality of representative points RN−1, RN, RN+1, and the like on the edge lines of the resist pattern P5 to be the determination target. In this example, the representative point RN−1 is adjacent to the representative point RN and the representative point RN is adjacent to the representative point RN+1.

After the representative points are set, the processing risk calculating unit 14 calculates SN−1 and SN as the minimum spaces at the representative points RN−1 and RN, respectively. Moreover, the processing risk calculating unit 14 in the present embodiment extracts both end points of the edge line on which the representative point is set and sets parallel lines with a predetermined width toward the peripheral pattern from the both end points. Then, the processing risk calculating unit 14 calculates area of a region surrounded by the two parallel lines, the edge line, and the peripheral pattern.

Specifically, the processing risk calculating unit 14 extracts both end points of the edge line on which the representative point RN−1 is set and sets parallel lines with a predetermined width toward a resist pattern 6P from the both end points. Then, the processing risk calculating unit 14 calculates area of a region surrounded by the two parallel lines, the edge line of the resist pattern P5, and the resist pattern P6 as the opening area (BN−1) near the representative point RN−1.

Moreover, the processing risk calculating unit 14 extracts both end points of the edge line on which the representative point RN is set and sets parallel lines with a predetermined width toward the resist pattern 6P from the both end points. Then, the processing risk calculating unit 14 calculates area of a region surrounded by the two parallel lines, the edge line of the resist pattern P5, and the resist pattern P6 as the opening area (BN) near the representative point RN.

Furthermore, the processing risk calculating unit 14 calculates a difference between the opening area near the representative point and the opening area near the representative point adjacent to this representative point. Specifically, the processing risk calculating unit 14 calculates an area difference ΔBN (absolute value) as a difference (change rate) between the opening area (BN−1) near the representative point RN−1 and the opening area (BN) near the representative point RN.

Then, the processing risk calculating unit 14 calculates the processed shape determination value D at each representative point by D=(area difference)/(minimum space). For example, the processing risk calculating unit 14 calculates the processed shape determination value D at the representative point RN by D=(ΔBN)/(SN).

The risk determining unit 15 determines whether the representative point is the danger point by comparing the calculated processed shape determination value D with a risk allowable range dr3. In the present embodiment, in the similar manner to the risk allowable range dr1 explained in the first embodiment, a test mask for setting the risk allowable range dr3 is generated in advance. Then, an actual pattern is formed on a wafer by using the test mask and this actual pattern is evaluated to set the risk allowable range dr3 in advance.

The representative point at which the processed shape determination value takes a large value is a point at which the opening area changes rapidly compared with the opening area near the adjacent representative point. When the processed shape determination value D indicates a value larger than the risk allowable range dr3, the representative point is highly likely to be the processing failure. The risk determining unit 15 extracts the representative point corresponding to the processed shape determination value indicating a value larger than the risk allowable range dr3 as the dangerous pattern. For example, in the case of the example shown in FIG. 10, the processed shape determination value D at the representative point RN becomes a large value, and if this processed shape determination value D is larger than the risk allowable range dr3, the representative point RN is extracted as the dangerous pattern. Then, after the dangerous pattern is extracted, the mask pattern is corrected so that the processed shape determination value at the representative point that becomes the dangerous pattern falls within the risk allowable range dr3. For example, the mask pattern is corrected to change SN or ΔBN (BN−1 or BN).

In the present embodiment, the area of the region surrounded by the parallel lines with the predetermined width extending from the both end points of the edge line toward the resist pattern P6, the edge line of the resist pattern P5, and the resist pattern P6 is set as the opening area near the representative point RN; however, the opening area can be calculated by the method explained in the first embodiment.

Next, a hardware configuration of the pattern determining apparatus 1 is explained. FIG. 11 is a diagram illustrating the hardware configuration of the pattern determining apparatus. The pattern determining apparatus 1 includes a CPU (Central Processing Unit) 91, a ROM (Read Only Memory) 92, a RAM (Random Access Memory) 93, a display unit 94, and an input unit 95. In the pattern determining apparatus 1, the CPU 91, the ROM 92, the RAM 93, the display unit 94, and the input unit 95 are connected via a bus line.

The CPU 91 executes determination of a pattern by using a pattern determining program 97 that is a computer program. The display unit 94 is a display device such as a liquid crystal monitor, and displays the mask pattern, the pattern edge, the representative point, the processed shape determination value, the determination result of the risk, and the like based on an instruction from the CPU 91. The input unit 95 is configured to include a mouse and a keyboard, and inputs instruction information (such as parameter necessary for pattern determination) that is externally input by a user. The instruction information input to the input unit 95 is sent to the CPU 91.

The pattern determining program 97 is stored in the ROM 92 and is loaded in the RAM 93 via the bus line. FIG. 11 illustrates a state where the pattern determining program 97 is loaded in the RAM 93.

The CPU 91 executes the pattern determining program 97 loaded in the RAM 93. Specifically, in the pattern determining apparatus 1, the CPU 91 reads out the pattern determining program 97 from the ROM 92, loads it in a program storage area in the RAM 93, and executes various processes, in accordance with the input of an instruction by a user from the input unit 95. The CPU 91 temporarily stores various data generated in the various processes in the data storage area formed in the RAM 93.

The pattern determining program 97 executed in the pattern determining apparatus 1 has a module configuration including the pattern data extracting unit 12, the representative point setting unit 13, the processing risk calculating unit 14, and the risk determining unit 15, which are loaded in a main storage device to be generated on the main storage device. The pattern determining apparatus 1 explained in the first embodiment and the second embodiment has a hardware configuration similar to the pattern determining apparatus 1 explained in the third embodiment.

In this manner, according to the third embodiment, the processed shape determination value is calculated by using a ratio between the difference of the opening area at the representative point to be the determination target and the opening area at the adjacent representative point and the minimum space at the representative point to be the determination target, and it is determined whether to be the processing failure after processing based on the calculated processed shape determination value, so that it is possible to easily and promptly determine whether to be the processing failure before the pattern formation.

According to the first to third embodiments, it becomes possible to easily and promptly determine whether to be the processing failure before the pattern formation.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method of determining a pattern comprising:
setting a first representative point as a position at which a pattern determination is performed on outline pattern data on a pattern formed in a process before a processed pattern to be a target for the pattern determination;
calculating a minimum distance from the first representative point to a peripheral pattern arranged around the pattern in which the first representative point is set;
calculating area of a region with no pattern, which is sandwiched by the pattern in which the first representative point is positioned and the peripheral pattern, in a region within a predetermined range from the first representative point, as a first opening area;
calculating processing failure information on possibility that the first representative point becomes a processing failure when the first representative point becomes the processed pattern, by using the minimum distance and the first opening area; and
determining whether the first representative point becomes the processing failure by comparing the processing failure information with a predetermined reference range.

2. The method according to claim 1, wherein the calculating the processing failure information includes calculating the processing failure information by dividing the first opening area by the minimum distance.

3. The method according to claim 1, further comprising:
setting a second representative point to be a target position of the pattern determination adjacent to the first representative point; and
calculating area of a region with no pattern, which is sandwiched by a pattern in which the second representative point is positioned and the peripheral pattern, in a region within a predetermined range from the second representative point, as a second opening area, wherein
the calculating the processing failure information includes calculating the processing failure information by dividing a difference between the first opening area and the second opening area by the minimum distance.

4. The method according to claim 1, further comprising, when it is determined that the first representative point becomes the processing failure, changing mask pattern data on the pattern formed in the process before the processed pattern so that the processing failure information falls within the predetermined reference range.

5. The method according to claim 4, wherein the changing the mask pattern data includes changing the mask pattern data so that the first opening area is changed.

6. The method according to claim 4, wherein the changing the mask pattern data includes changing the mask pattern data so that the minimum distance is changed.

7. The method according to claim 1, further comprising, when it is determined that the first representative point becomes the processing failure, changing a process condition of the pattern formed in the process before the processed pattern so that the processing failure information falls within the predetermined reference range.

8. The method according to claim 1, wherein the processed pattern is a pattern formed by using a side-wall processing process.

9. The method according to claim 1, wherein the process before the processed pattern is any of forming a resist pattern, slimming a pattern, depositing a side-wall film, and removing a core of the side-wall film.

10. The method according to claim 9, wherein the predetermined reference range is a range in accordance with a type of the process before the processed pattern.

11. The method according to claim 1, wherein the predetermined reference range is a range that is set based on a processing simulation using mask data on a test mask or an on-substrate pattern that is actually processed by using the test mask.

12. The method according to claim 1, further comprising generating the outline pattern data by using any of pattern data on a pattern calculated by a simulation, design layout data used for forming the processed pattern, and an on-substrate pattern that is actually processed.

13. The method according to claim 1, wherein the determining whether the first representative point becomes the processing failure is performed on the first representative point whose calculated minimum distance is smaller than a predetermined value.

14. A method of determining a pattern comprising:
setting a first representative point as a position at which a pattern determination is performed on outline pattern data on a pattern formed in a process before a processed pattern to be a target for the pattern determination;
setting a second representative point to be a target position of the pattern determination adjacent to the first representative point;
calculating a first minimum distance from the first representative point to a peripheral pattern arranged around the pattern in which the first representative point is set;
calculating a second minimum distance from the second representative point to a peripheral pattern arranged around the pattern in which the second representative point is set;
calculating processing failure information on possibility that the first representative point becomes a processing failure when the first representative point becomes the processed pattern, by using a ratio between the first minimum distance and the second minimum distance; and
determining whether the first representative point becomes the processing failure by comparing the processing failure information with a predetermined reference range.

15. The method according to claim 14, further comprising, when it is determined that the first representative point becomes the processing failure, changing mask pattern data on the pattern formed in the process before the processed pattern so that the processing failure information falls within the predetermined reference range.

16. The method according to claim 14, further comprising, when it is determined that the first representative point becomes the processing failure, changing a process condition of the pattern formed in the process before the processed pattern so that the processing failure information falls within the predetermined reference range.

17. The method according to claim 14, wherein the processed pattern is a pattern formed by using a side-wall processing process.

18. The method according to claim 14, wherein the process before the processed pattern is any of forming a resist pattern, slimming a pattern, depositing a side-wall film, and removing a core of the side-wall film.

19. The method according to claim 18, wherein the predetermined reference range is a range in accordance with a type of the process before the processed pattern.

20. The method according to claim 14, wherein the predetermined reference range is a range that is set based on a processing simulation using mask data on a test mask or an on-substrate pattern that is actually processed by using the test mask.
